(19) United States
(12) Patent Application Publication
(10) Pub. No.: US 2010/0063886 A1
(43) Pub. Date: Mar. 11, 2010

(54) METHODS AND SYSTEMS FOR PRODUCING AN ENTERTAINMENT PRODUCT

(76) Inventors: Dennis Stratton, New York, NY (US); Roy Klabin, New York, NY (US); Zack Roth, Venice, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/555,636

(22) Filed: Sep. 8, 2009

Related U.S. Application Data
(60) Provisional application No. 61/094,767, filed on Sep. 5, 2008.

(51) Int. Cl. G06Q 40/00; G06Q 50/00; G06Q 30/00; G06F 3/048

(52) U.S. Cl. 705/14.73; 705/37; 715/733

(57) ABSTRACT

Methods and systems for producing one or more entertainment products. A project investment vehicle (PIV) for the entertainment product is created, where the PIV includes a prospectus. After identification of a producer and/or a distributor of the entertainment product, production of the entertainment product is started only when sufficient capital is raised from selling shares in the PIV to investors. Collaboration, among at least three of a production entity, prospective talent, prospective investors, and prospective consumers of the entertainment product is enabled via a web-based platform hosted by at least one server.

### CROSS REFERENCE TO RELATED APPLICATION

The present application claims the benefit of U.S. Provisional Application Ser. No. 61/094,767, filed on Sep. 5, 2008, which is incorporated herein by reference in its entirety.

### FIELD OF THE INVENTION

The present invention relates to production systems and methods for entertainment products, such as movies, musical recordings and/or videos, and computer games.

### BACKGROUND

There is a long-held need in the entertainment industry for more effective means to identify, finance, produce and distribute profitable projects. For example, with reference to the motion picture industry, Warner (US 2007/0100641) discloses that of the approximately six thousand films produced per year, less than one hundred are widely released and only a fraction of the widely released films generate healthy financial returns. It is evident that present methods are grossly inefficient to (1) identify potentially lucrative projects for financing, and (2) finance and produce products with an acceptable probability of generating an attractive return for investors.

According to present business methods, as exemplified in the traditional “Hollywood” style of the motion picture industry, production decisions are made behind closed doors and by a very small number of people. For so-called “major” motion pictures, a prerequisite for a starting a project is well known talent, such as a famous movie star or director, and/or a preexisting franchise or fan base (based, for example, on an earlier successful film or novel). Such projects are expensive, because of the need to pay for proven talent and/or intellectual property, but they make up by far the largest fraction of the widely released films. Notwithstanding a significant fraction of “flops” enough of such major motion pictures generate positive financial returns to keep the motion picture industry as a whole financially viable.

So-called “low budget” motion picture projects, on the other hand, have difficulty raising money to advance beyond the screen play phase. If a project does receive sufficient financing to produce a film, the film is only rarely profitable to the film producer and investors, even if the film succeeds in making money for distributors and exhibitors of the films. Nevertheless, certain low-budget films have produced spectacular financial results. For example, the film Napoleon Dynamite was reportedly produced at a cost of less than $500,000 but has generated gross revenues of over $46 million.

The success of films like Napoleon Dynamite and the Harold and Kumar films demonstrates that there is a significant demand and upside potential for low budget youth comedies that traditionally did not fall within the revenue generation requirements of major studios. These films have produced remarkable revenues even without recourse to previously well known acting/directorial talent (and benefited from substantially lower production cost by avoiding such “famous” talent). Nevertheless, these films are the rare exception to the general record of independent films that either never receive financing, or that, having been financed, failed to return a profit to the investors.

Thus, there is a need for improved methods and systems for selecting, financing, and promoting entertainment products and, in particular, to a system and method for facilitating collaboration and interaction among a production entity and related stakeholders on the one hand, and talent, investors, and fans on the other.

### SUMMARY OF THE INVENTION

The methods and systems disclosed herein provide for enabling production of one or more entertainment products by creating a project investment vehicle (PIV) for the entertainment product, where the PIV includes a prospectus. After identification of a producer and/or a distributor of the entertainment product, production of the entertainment product is started only when sufficient capital is raised from selling shares in the PIV to investors. Collaboration, among at least three of a production entity, prospective talent, prospective investors, and prospective consumers of the entertainment product is enabled via a web-based platform.

In an embodiment revenue is received from distribution, sale and/or exhibition of the at least one entertainment product.

In a further embodiment, the PIV is organized as a corporation, a partnership, a limited partnership, a limited liability company or a mutual fund.

In another embodiment, the entertainment product is a film.

In an embodiment, the prospectus describes a deal memorandum between the production entity and a distributor, studio, screenwriter, author, and/or director.

In yet another embodiment, collaboration is enabled by: enabling at least one of the production entity and prospective consumers to evaluate the prospective talent; enabling prospective investors to purchase shares in the PIV; enabling investors and prospective investors to participate in a secondary market for shares in the PIV; enabling investors to participate in production decisions related to the at least one entertainment product; and/or enabling a visitor to the web-based platform to actively market the entertainment product.

In a further embodiment, collaboration is enabled by: enabling at least one of the production entity and prospective consumers to evaluate the prospective talent; enabling investors to participate in production decisions related to the at least one entertainment product; and/or enabling a visitor to the web-based platform to actively market the entertainment product. Moreover collaboration may be enabled by enabling prospective investors to purchase shares in the PIV in which case investors may be further enabled to participate in a secondary market for shares in the PIV; and be provided access to investor information relating to the PIV via the platform.

In an embodiment, wherein the producer, distributor and/or talent are provided with compensation in the form of shares or an interest in the PIV. Further, the compensation may be a portion of the total compensation provided to the producer, distributor and/or talent.

In another embodiment, production of an entertainment product is enabled by: creating a project investment vehicle (PIV) for the entertainment product, where the PIV includes a prospectus; identifying a producer and/or a distributor of the entertainment product; and enabling collaboration, via a web-based platform, among a production entity, prospective talent, prospective investors, and prospective consumers of the entertainment product; and starting production of the at least one entertainment product, only when sufficient capital is raised from selling shares in the PIV to investors. Enabling collaboration may include: evaluation of prospective talent by at least one of the production entity and prospective consumers; participation in production decisions related to the at least one entertainment product by investors; and, active marketing of the entertainment product by a visitor to the web-based platform.

### BRIEF DESCRIPTION OF THE DRAWINGS

Embodiments are illustrated by way of example, and not limitation, in the figures of the accompanying drawings, in which:

FIG. 1 is a flow diagram of an exemplary embodiment of an entertainment product production method;

FIG. 2 is diagram illustrating organization of a virtual space for use in an exemplary embodiment.

FIG. 3 is a diagram illustrating an exemplary embodiment of an entertainment product production system.

### DETAILED DESCRIPTION

Described herein are systems and methods for creating a low-cost, managed risk approach to production of an entertainment product, while meeting the public's increasing interest for involvement in the production process. As described below, untapped talent and potential investors are identified by enabling collaboration and interaction among a production entity and related stakeholders on the one hand, and talent, investors, and fans on the other. Thereby a mechanism is provided for exposing and evaluating artists, attracting fans (some of whom may become investors), and improving the risk/reward ratio of a production project.

As used herein, the term “producer” may be an entity that selects a project concept for production, manages and provides initial financing for the production, and selects key talent to execute the project and/or a co-producer that works with or for the producer. In certain contexts, the producer may be called an executive producer and the co-producer may be called the producer. Herein the term “producer” refers to each or all of those entities. In the context of a film project, for example, the producer may perform one or more of the following: hire a co-producer, select a screenplay and a director, negotiate a distribution contract, and prepare a production budget. The producer may oversee and approve preparation of an investment vehicle appropriate to finance the budget. The methods and systems described herein may be performed and/or used by or on behalf of the producer.

In the discussion which follows, embodiments are described, by way of example, with particular reference to a film project, and, more specifically, a low budget, youth-oriented film project. It will be evident to those of skill in the art that the methods and systems described hereinbelow can be readily adapted to other genres of film, and to other entertainment media. For example, music audio and video recordings, computer games, theatrical productions, virtual world computer environments, theme park attractions, and the like may all be produced using the teachings of the present disclosure and are encompassed within the scope of the present claims.

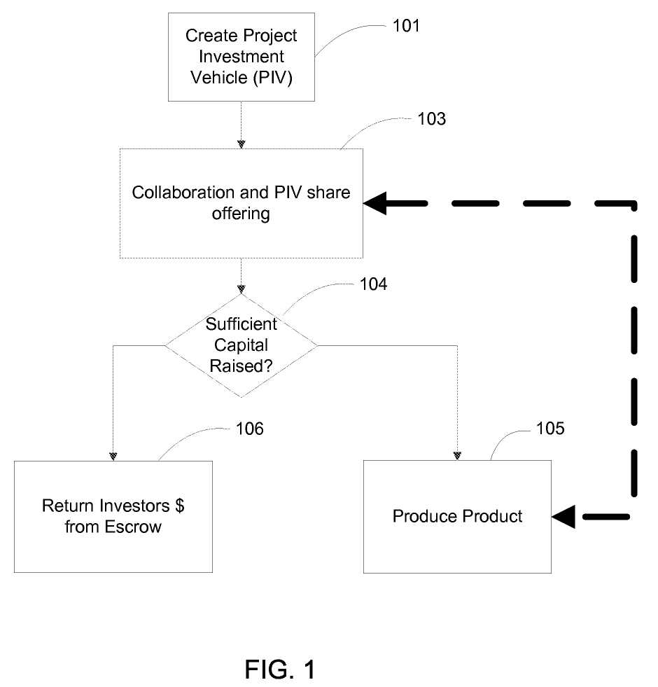

Referring now to FIG. 1, a method embodiment 100 will be described.

At step 101, a project investment vehicle (PIV) is created. The PIV may be described in a prospectus or offering memorandum (hereinafter, the “prospectus”) and may be structured as a business entity in which membership interests or shares (hereinafter, “shares”) are publicly or privately offered. For example, the PIV may be structured as a corporation, a limited liability company or a limited partnership. The particular form of the PIV is not significant, and those with skill in the art will recognize that many such forms are available. As initially created at step 101, assets of the PIV may comprise production and distribution rights to at least a project concept, for example, a screenplay. Such rights may be memorialized by a “deal memorandum” between a producer and one or more of a co-producer, distributor, studio, screenwriter, author, and a director. In an embodiment, the PIV may include rights to two or more project concepts, thereby providing diversity and reducing the financial risks of the PIV. In an embodiment, the PIV may include a contract with an established film distributor to release a specified volume of films per year. For example, three low-budget, youth comedies per year may form the basis of a distribution contract.

With reference to an exemplary film industry embodiment of the method, step 101 may include the producer acquiring rights to a screenplay. Advantageously, the producer may acquire these rights through a relationship with a university, through a screen writing competition, and/or a smaller talent agency. Alternatively, or in addition, the producer may acquire rights from a catalogued talent base to ensure a steady flow of quality content. As a further example, the producer may finance and produce a screenplay acquired through New York University's Tisch Film School or through co-sponsoring a screenwriting competition with such websites as scriptpimp.com. Moreover, the producer may also use traditional means to acquire the screenplay, for example, through a relationship with one or more smaller talent agencies and/or managers. Using one or more of the above sources, the producer may acquire rights to several screenplays. Advantageously, the producer may acquire rights to at least as many screenplays as there are films subject to the distribution contract. In this example, at step 101 the PIV may be based on the screenplays to which rights have been acquired. The PIV may be described in the prospectus and may include as elements, for example, the producer agreement, the distribution contract, the screenplay(s), investor information, and investment contract terms.

Prior to offering shares in the PIV, the shares may be registered under the Securities Act of 1933 (the “Securities Act”) and registered or qualified under state securities laws (the “blue sky laws”). Alternatively, the shares may be offered pursuant to an exemption from the registration requirements of the Securities Act and the registration or qualification requirements of the blue sky laws.

Upon completion of any securities filings with the Securities and Exchange Commission and state regulatory bodies, prospective investors may be provided, at step 103, an opportunity to financially participate in the PIV. The opportunity may be provided by way of a link over a network to an “investor section” of a web-based platform or other virtual space (hereinafter, the “website” or the “web-based platform”) wherein the producer and other stakeholders in a project are enabled to collaborate with persons having potential interest in the project. Advantageously, the website will attract prospective talent, prospective investors and prospective consumers/audience members (hereinafter “prospective consumers”) to interact and collaborate with each other and with the producer. The website may be hosted on one or more servers, and be communicatively coupled, via the network, to a plurality of potential collaborators. A more detailed description of an exemplary web site suitable for this aspect of the method step is provided below.

The PIV may be structured such that the producer, distributor and/or talent are offered compensation in shares of the PIV in lieu of or in addition to cash remuneration. This would align the interests of all of the entities involved in a project and would provide an upside benefit to the producer, distributor and/or talent. It also would reduce the level of capital needed to be raised to begin producing the entertainment product.

Advantageously, financial participation in the PIV provided at step 103 may include terms under which investors' funds are initially deposited into an escrow account or other similar instrument. In such case, the amount of funds received in escrow may be a metric used to judge whether to start production of the entertainment product. For example, the PIV may have a contractual term providing that expenditures for the production of the entertainment product are permitted only after sufficient capital is raised at step 103. Sufficient capital may be defined in terms of an anticipated budgeted total cost, for example, 90% of an anticipated budgeted total cost.

At step 104, a decision point may be provided as to whether sufficient capital has been raised within a preset period of time. If not, invested funds are returned to investors, step 106. If sufficient capital has been raised, however, producing the entertainment product, step 107 may start.

As indicated by the dashed line in FIG. 1, collaboration step 103 may be an ongoing process, facilitated by the website, during a production of the entertainment product. For example, in an early phase of a film production, auditions for screen roles may be offered to prospective talent or other selected visitors to the website. Investors may be afforded the opportunity to participate in some production decisions, and may be encouraged to engage in viral marketing activities, for example.

Moreover, an aspect of the collaboration step 103 may include provisions for a secondary market in shares in the PIV. In an embodiment, a broker/dealer may organize a secondary market for such shares. Such a market may reduce risks for the investors, while offering the opportunity for speculators to provide liquidity and to attempt to profit from volatility in a PIV's market price.

A further aspect of collaboration step 103 may include provisions for interested website visitors and investors to actively participate in marketing and sales of the entertainment product. Such individuals may be mobilized and incentivized to spread awareness of the entertainment product within their own communities, thereby enabling a more cost-effective grass-roots marketing campaign.

In a further embodiment, a system for facilitating public participation in the selection and financing of an entertainment project, such as a motion picture, is provided, thereby improving the risk/reward profile of such a project. For example, the system may facilitate investment in the PIV by members of the public, who may advantageously also be “fans” of a particular film genre or artist. Such investors, collectively, may finance substantial portions of a project's development and production costs by purchasing shares in the PIV. In an embodiment, the PIV may include a basket of two or more films. Advantageously, the films may be, for example, low budget youth comedies, or other genres, targeted at web-savvy audiences underserved by the present film production business method.

A system embodiment may include a multi-layered, web-based platform or virtual space (hereinafter, referred to as the “website” or the “web-based platform”) operated by, or on behalf of, a film producer or production company (hereinafter, the “producer”) and hosted on one or more servers. The website may be designed to facilitate collaboration and interaction among the producer and related project stakeholders on the one hand, and fans, artists, and investors on the other. Website visitors may be comprised primarily of fans looking for a more intimate movie making experience. As discussed hereinbelow, some website visitors may include aspiring talent (e.g., comics, actors, writers, game designers); additionally, or alternatively, some individuals may become film investors or compete for the opportunity to be selected as talent. Other individuals may be attracted to repeatedly visit the web site to enjoy content posted in various sections of the website.

One layer (or “section”) of the website, termed the “talent section”, may serve as a platform wherein “talent”, such as comedians, actors, writers, musicians and the like, post their work. The talent section may provide entertainment content to attract visitors to the website, while offering the talent exposure to potential fans and to those involved in selecting personnel for a production.

A second layer, termed the “investor section”, may provide a link by which website visitors may access information regarding investment opportunities in one or more entertainment projects. Among other functionality, the investor section of the web site may enable an interested person to become an investor. As such, the investor may co-finance and thus take fractional ownership in a production of one or more projects, as well as evaluate, rank and cast aspiring talent for those projects. In an embodiment, the web site may provide the investor an opportunity to invest in a project investment vehicle (or “PIV”). The PIV may include a bundle of two or more films, thereby offering diversity and reducing financial risk. In an embodiment, the investor section may provide access to a secondary market for the investment product.

A third layer, termed the “production section”, may provide content related to one or more particular entertainment products. The depth and variety of the content accessible to a website visitor may vary, depending on the individual's status. For example, movie production stills, cast bios and interviews, and the like may be offered for viewing by any website visitor, while premium content, such as outtakes, production videos, and offers to obtain movie “swag”, and/or participate in movie premiers, or casting calls, may only be provided to investors. Additionally, this section may provide web or other access for investors to view and post comments related to, for example, periodic video diaries from a production cast and/or crew, blog entries from a production's director, producer, and/or talent, behind-the-scenes footage and/or outtakes, story board animation for given scenes, computer game prototype demonstrations, messages between other PIV investors, etc.

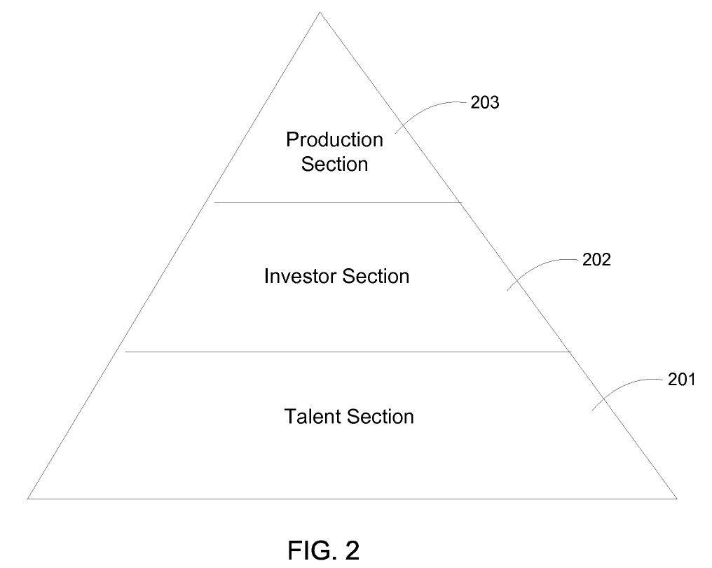

Referring now to FIG. 2, an embodiment of the web-based platform (or “website”) 200 will be described in more detail.

A talent section 201 may be adapted to provide a venue for up and coming talent to gain exposure and public recognition through their web profiles and their interaction with website visitors. Advantageously, at least a portion of the talent section 201 is available for posting of material only by aspiring talent invited by a professional production entity, to ensure high quality. Thus, the website may provide promising but relatively unknown artists a central location to post rich content such as video clips, blogs, stand up tour schedules, links to other sites, etc. The talent section 201 may provide a principle attraction to casual web visitors, as well as providing a showcase where candidate artists may be evaluated by professionals. Contributions by talent may be incentivized by reserving certain roles in a film production for talent contributors only.

A substantial portion of content posted on the talent section 201 of the website may be accessed by any website visitor. In an embodiment, the talent section 201 may be segregated by age appropriateness, with certain content restricted, for example to website visitors who have provided evidence of being older than a particular age. Most content, whether age-restricted or not, may be viewable at no charge, and individuals may be attracted to frequently visit the website, by creation of a multi-faceted, dynamic and frequently updated virtual environment/experience. Features may include, for example, periodic contests and an opportunity to rank talent based on the entertainment value of their posted content. For example, posted videos of stand-up routines of comics may be ranked by the website visitors. Advantageously, for example, a producer may give the higher ranking talent an opportunity to play a role in an upcoming film production.

As mentioned above, the web-based platform 200 may facilitate participation and repeat visitation by providing a multi-faceted, dynamic and frequently updated virtual environment/experience. In addition to accessing contributions found in the talent section 201, competitions may be conducted that relate to themes of a current production (e.g., if a film production is a related to ghosts, competitors may be invited to submit short comic videos involving the supernatural). Competition winners may receive movie “swag” as prizes (e.g., production logo'd t-shirts, hats, etc., tickets to red carpet events) and/or film grants to produce comedic shorts for the website.) Continued participation in contests may be encouraged by awarding, for example, “stripes” to individuals and providing them an opportunity post a personal profile incorporating such “stripes”. Frequent winners may be considered for roles in future productions and/or invited to make contributions to the talent section 201.

In addition, website visitors may be given an opportunity to post personal profiles and to interact with each other and with “talent” through chat rooms, bulletin boards, and the like and encouraged to endorse. The profiles may include entertainment content, and website visitors will be encouraged to endorse or recommend the content of other posters. Such endorsements, in a similar manner to the contest awards discussed above, may be considered as “stripes”, and individuals having enough such stripes may be invited to make contributions to the talent section 201.

Website visitors may be afforded opportunities to customize their profiles by, for example, electing to segment their profile, such that some of it is viewable by the entire community, some by only friends or fans, and some by only talent agency or management companies. Such talent or management agencies may be charged a subscription fee to access these private portfolios.

Website visitors may be given an opportunity to interact with each other and with “talent” through chat rooms, bulletin boards, personal profiles, and the like, but, relative to the talent, may in general be afforded less privileged posting opportunities. As mentioned above, according to an embodiment, talent are screened and selected by or on behalf of the producer. As such, talent may be advantageously afforded opportunities to post a greater diversity and volume of content than ordinary website visitors. Limiting such enhanced opportunity to post content only to talent may serve to avoid website clutter, reduce bandwidth/storage demands on the website and host servers, incentivize talent to contribute material to the website, and incentivize ordinary website visitors to aspire toward becoming talent. As discussed above, website visitors aspiring to become “talent” may be offered frequent opportunities to demonstrate their own potential through contests, web-based “open mike” try-outs, entertaining profiles, etc. Thus, continued collaboration and participation is encouraged, by offering repeat visitors the opportunity to “earn their stripes” by garnering sufficient on-site popularity as a result of creating original entertaining content for other website visitors to evaluate and rank. Finally, individuals may also be encouraged and incentivized to promote sales of one or more entertainment products.

Investor section 202 may provide information for web-site visitors interested in becoming investors. Portions of section 202 may be open to any member of the public. Links to certain content may be accessible only to qualified prospective investors and/or to those who have made an investment. A publicly accessible portion of investor section 202 may include conventional investor relations materials, FAQ's, links to public filings, etc. A portion of investor section 202 may enable or act as a portal to a secondary market mechanism for the PIV.

Production section 203 may provide project specific information regarding, for example a film production. A portion of production section 203 may be open to any member of the public and include conventional promotional and marketing information. An additional portion of production section 203 is advantageously accessible only to investors and/or selected, particularly active web-site visitors (hereinafter, “fans”). This portion may include access to special opportunities relative to a production or marketing process of the PIV. For example, investors may be given an opportunity to participate in certain casting and production decisions, for example by voting, and to participate in special surveys related to production decisions.

Advantageously, investors and/or fans may be given tools, information and encouragement to engage in viral marketing of the project. In addition, for example, investors and/fans may access other special privileges through this portion of the website, e.g., opportunities to view or purchase special production stills, props and costumes, participate in contests for invitations to premiers, on-line “chat” with film stars and directors, or a chance to be cast for a bit part, etc. Other benefits may extend to automatic entrance into competitions, such as, for example, competitions for a role to assist in actual trailer production. Additional benefits may include, for example, the right to choose or vote on such matters as end credits music, other music cues, wardrobe for given characters in given scene, props for given scenes (animals, posters, etc.), and/or stunts. Advantageously, such input on these matters may be subject to parametric controls set by the producer and/or director in compliance with budgetary, aesthetic and other top-level project objectives.

The investors and/fans may be incentivized to market the production locally in their communities, nationally and via various media and mediums, such as, for example, their existing contact lists, web sites, business partners and affiliates. An investor or fan may be given the opportunity or ability to sell tickets through the investor's own on-line profile, which may be, for example, linked to other social networking sites. The investor or fan may be provided further rewards or incentives for achieving certain sales levels or milestones, such as an expanded opportunity to play a role in the production of a future related entertainment product.

A collaboration community enabled by the system described above may thus include investors, artists, production professionals and fans. Growth of the community may be encouraged by reserving exclusive opportunities for members to audition for various roles in an entertainment production. Such auditions may be viewable by members of the community through the website. For example, the community may be given the opportunity to vote on the results of the auditions. The highest ranked auditions based on such votes may result in one or more winners competing in the final auditions for certain roles in the entertainment product.

Additionally, the system and method may include a reality show that will be broadcast on the entertainment product website relating to the public auditions. Alternatively or additionally, the system and method may provide a link up to allow for hosting of auditions through MySpaceTV or other digital distribution platforms.

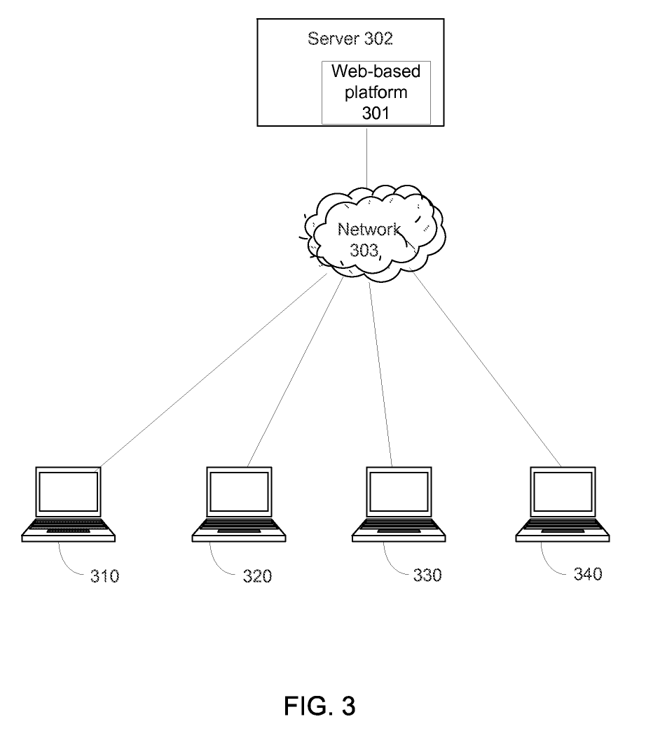

Referring now to FIG. 3, a system embodiment may include web-based platform 301 hosted by at least one server 302. Server 302 may be communicatively coupled via network 303, which may be, for example the Internet, or a wired or wireless local area network. Thus, web-based platform 301 may be accessed by a number of individual collaborators by way of personal computer workstations, personal digital assistants, smart phones, and the like. By way of an illustrative example, a production entity 310, prospective talent 320, prospective investors 330 and prospective consumers 340 may access and interact with the web-based platform via the network, in the manner described hereinabove.

Thus, in accordance with the methods and systems described above, whether a web-site visitor is an enthusiast of an entertainment genre, a fan of a particular talent, or an investment savvy individual, he or she can invest in an entertainment product closely tied to the individual's interest. As elaborated below, the methods and systems described herein offer several advantages over conventional means to important stakeholders in, for example, the film industry.

Film distributors, for example, may gain access to an expanded pipeline of films, without having to incur production and development costs. A film portfolio developed with the methods and systems described above relieves the distributor of financing certain production costs as well as development and completion costs. In an embodiment, a studio and/or distributor is provided with a lower-risk investment by providing a “last-in, first-out” distribution opportunity. Through the talent section of the website, the distributor gains the advantage of being exposed to new actors, some potentially being the next big stars. Although distribution partners may remain responsible for covering print and advertising costs, web-site visitors and investors may be mobilized and incentivized to spread awareness within their own communities. As a result, the methods and systems described above may reduce marketing costs by encouraging self-interested consumer/investor marketers to lead grass-roots ad campaigns.

Aspiring talent may be provided a platform to post work, gain public recognition and potentially take part in a major motion picture. The talent section of the website may offer exclusive invitations to handpicked talent and thus provide a platform to gain public recognition. Thereby, the talent may be enabled to have exclusive use of specific web pages within the talent section of the web site from which they may showcase their acts or other works, and connect with an audience of production professionals as well as ordinary web-site visitors. The audience may be afforded the opportunity to vote on these web pages, and the talent having the highest rated profiles may be considered for a role in a production. Additionally, individuals classified as talent may be encouraged to collaborate and network with each other in the web site community. In addition, for example, such individuals may be afforded the right to issue a pre-set number of invitations to other prospective talent, thereby encouraging expansion of the website's talent base.

Web-site visitors may be given the ability to finance and become involved in, for example, a movie making experience. Individuals who become equity holders in a film portfolio may be afforded special access to the films as they are being developed and produced. If the film portfolio sees a return on investment, the investor will recoup capital through box office sales, as well as DVD, TV, and other ancillary sales and merchandising. Web-site visitors may also be incentivized to become investors. For example the producer may provide opportunities exclusively to investors to participate in premieres, producer-sponsored events and/or small roles in a film. Such participation may be conditioned on the size of a person's investment, or be awarded to interested investors through contests, raffles, or the like.

Investment-savvy individuals may be interested more in the scalability of a motion picture and the unique risk/reward profile of a project-oriented, yet securitized investment instrument. Investors with an appetite for risk may be lured by the opportunity to take a large stake in the next ‘Napoleon Dynamite’ or ‘Harold and Kumar’.

A web-site visitor, whether or not an investor, may enjoy periodic opportunities to submit video clips of their own with the intention of gaining enough onsite popularity to eventually be considered as talent.

Embodiments involve computer software and hardware, for example in the form of servers, personal computers, and the like. Such devices and software generally execute algorithms which implement method embodiments. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the present disclosure, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

Embodiments may be implemented with apparatus to perform the operations described herein. This apparatus may be specially constructed for the required purposes, or may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

One of ordinary skill in the art will immediately appreciate that the teachings of the present disclosure may be practiced with computer system configurations other than those described above, including hand-held devices, multiprocessor systems, microprocessor-based or programmable consumer electronics, DSP devices, network PCs, minicomputers, mainframe computers, and the like, as well as in distributed computing environments where tasks are performed by remote processing devices that are linked through a communications network. The required structure for a variety of these systems will appear from the description above.

Thus, production methods and systems for entertainment products, such as movies, musical recordings and/or videos, and computer games have been described that facilitate collaboration and interaction among a production entity and related stakeholders on the one hand, and talent, investors, and fans on the other.

The foregoing merely illustrates principles and exemplary embodiments of the invention. It will thus be appreciated that those skilled in the art will be able to devise numerous systems and methods which, although not explicitly shown or described herein, embody said principles of and are thus within the spirit and scope of the following claims.

What is claimed is:

1. A method for enabling production of at least one entertainment product, said method comprising:
creating a project investment vehicle (PIV) for the at least one entertainment product, said PIV comprising a prospectus;
identifying at least one of a producer and a distributor of the at least one entertainment product;
enabling collaboration, via a network, among at least three of a production entity, prospective talent, prospective investors, and prospective consumers of the at least one entertainment product, said collaboration at least partly instantiated by a web-based platform hosted by at least one server; and
starting production of the at least one entertainment product, only when sufficient capital is raised from selling shares in the PIV to investors.

2. The method of claim 1, further comprising receiving revenue from at least one of distribution, sale and exhibition of the at least one entertainment product.

3. The method of claim 1, wherein the at least one entertainment product comprises a plurality of entertainment products.

4. The method of claim 1, wherein the PIV is organized as one of a corporation, a partnership, a limited partnership, a limited liability company and a mutual fund.

5. The method of claim 1, wherein the at least one entertainment product is a film.

6. The method of claim 5, wherein the prospectus describes a deal memorandum between the production entity and at least one of a distributor, studio, screenwriter, author, and director.

7. The method of claim 1, wherein enabling collaboration further comprises at least one of:
enabling at least one of the production entity and prospective consumers to evaluate the prospective talent;
enabling prospective investors to purchase shares in the PIV;
enabling investors and prospective investors to participate in a secondary market for shares in the PIV;
enabling investors to participate in production decisions related to the at least one entertainment product; and
enabling a visitor to the web-based platform to actively market the entertainment product.

8. The method of claim 1, wherein enabling collaboration further comprises:
enabling at least one of the production entity and prospective consumers to evaluate the prospective talent;
enabling investors to participate in production decisions related to the at least one entertainment product; and
enabling a visitor to the web-based platform to actively market the entertainment product.

9. The method of claim 8, further comprising enabling prospective investors to purchase shares in the PIV.

10. The method of claim 9, further comprising at least one of:
enabling investors and prospective investors to participate in a secondary market for shares in the PIV; and
providing the prospective investors access to investor information relating to the PIV via the web-based platform.

11. The method of claim 1, wherein at least one of the producer, distributor and talent is provided with compensation in the form of shares or an interest in the PIV.

12. The method of claim 11, wherein the compensation in the form of shares or an interest in the PIV is a portion of the total compensation provided to the at least one of the producer, distributor and talent.

13. A method for enabling production of at least one entertainment product, said method comprising:
creating a project investment vehicle (PIV) for the at least one entertainment product, said PIV comprising a prospectus;
identifying at least one of a producer and a distributor of the at least one entertainment product;
enabling collaboration, via a network, among a production entity, prospective talent, prospective investors, and prospective consumers of the at least one entertainment product, said collaboration at least partly instantiated by a web-based platform hosted by at least one server, wherein said collaboration comprises:
evaluation of prospective talent by at least one of the production entity and prospective consumers,
participation in production decisions related to the at least one entertainment product by investors, and
active marketing of the entertainment product by a visitor to the web-based platform; and
starting production of the at least one entertainment product, only when sufficient capital is raised from selling shares in the PIV to investors.

14. A system for enabling production of at least one entertainment product, comprising:
a project investment vehicle (PIV) for the at least one entertainment product, said PIV comprising a prospectus that identifies at least one of a producer and a distributor of the at least one entertainment product; and
at least one server hosting a web-based platform, the web-based platform enabling collaboration among at least three of a production entity, prospective talent, a prospective investor, and a prospective consumer of the at least one entertainment product, wherein production of the at least one entertainment product is begun only when sufficient capital is raised from selling shares in the PIV to investors.

15. The system of claim 14, wherein revenue is received from at least one of distribution, sale and exhibition of the at least one entertainment product.

16. The system of claim 14, wherein the at least one entertainment product comprises a plurality of entertainment products.

17. The system of claim 14, wherein the PIV is organized as one of a corporation, a partnership, a limited partnership, a limited liability company and a mutual fund.

18. The system of claim 14, wherein the at least one entertainment product is a film.

19. The system of claim 18, wherein the prospectus describes a deal memorandum between the production entity and at least one of a distributor, studio, screenwriter, author, and director.

20. The system of claim 14, wherein the web-based platform further enables collaboration by at least one of enabling at least one of the production entity and prospective consumers to evaluate the prospective talent, enabling prospective investors to purchase shares in the PIV, enabling investors and prospective investors to participate in a secondary market for shares in the PIV, enabling investors to participate in production decisions related to the at least one entertainment product, and enabling a visitor to the web-based platform to actively market the entertainment product.

21. The system of claim 14, wherein the web-based platform further enables collaboration by at least one of enabling at least one of the production entity and prospective consumers to evaluate the prospective talent, enabling investors to participate in production decisions related to the at least one entertainment product, and enabling a visitor to the web-based platform to actively market the entertainment product.

22. The system of claim 21, further comprising enabling prospective investors to purchase shares in the PIV.

23. The system of claim 22, wherein the web-based platform further comprises at least one of:
enabling investors and prospective investors to participate in a secondary market for shares in the PIV; and
providing the prospective investors access to investor information relating to the PIV via the platform.

24. The system of claim 14, wherein at least one of the producer, distributor and talent is provided with compensation in the form of shares or an interest in the PIV.

25. The method of claim 24, wherein the compensation in the form of shares or an interest in the PIV is a portion of the total compensation provided to the at least one of the producer, distributor and talent.

26. A system for enabling production of at least one entertainment product, comprising:
a project investment vehicle (PIV) for the at least one entertainment product, said PIV comprising a prospectus that identifies at least one of a producer and a distributor of the at least one entertainment product; and
at least one server hosting a web-based platform that enables collaboration among a production entity, prospective talent, prospective investors, and prospective consumers of the at least one entertainment product, wherein said collaboration comprises:
evaluation of prospective talent by at least one of the production entity and prospective consumers,
participation in production decisions related to the at least one entertainment product by investors, and
active marketing of the entertainment product by a visitor to the web-based platform, wherein production of the at least one entertainment product is begun only when sufficient capital is raised from selling shares in the PIV to investors.
